(19) United States
(12) Patent Application Publication
(10) Pub. No.: US 2022/0295213 A1
(43) Pub. Date: Sep. 15, 2022

(54) SIGNAL PROCESSING DEVICE, SIGNAL PROCESSING METHOD, AND PROGRAM

(71) Applicant: SONY GROUP CORPORATION, TOKYO (JP)

(72) Inventor: KENJI NAKANO, TOKYO (JP)

(21) Appl. No.: 17/629,493

(22) PCT Filed: Jul. 17, 2020
(86) PCT No.: PCT/JP2020/027776

§ 371 Date: Jan. 24, 2022

(30) Foreign Application Priority Data
Aug. 2, 2019 (JP) 2019-143031

(51) Int. Cl. H04S 7/00; H04S 1/00; H04R 5/04; H04R 5/033

(52) U.S. Cl. CPC H04S 7/304; H04S 7/307; H04S 1/005; H04R 5/04; H04R 5/033; H04S 2420/01

(57) ABSTRACT

The present technology relates to a signal processing device, a signal processing method, and a program for reducing the amount of signal processing.

A signal processing device includes a first convolution processing section that performs convolution of an audio signal with a difference filter for adding a characteristic of the difference between a transmission characteristic of a path from a first position on the circumference of a cone of confusion to a listening position and a transmission characteristic of a path from a second position on the circumference to the listening position, and a notch forming section that performs a filtering process on a signal resulting from the convolution, by using a notch forming filter for forming a high-pass notch. The present technology is applicable to a signal processing device.

### TECHNICAL FIELD

The present technology relates to a signal processing device, a signal processing method, and a program, and more specifically, relates to a signal processing device, a signal processing method, and a program for reducing the amount of signal processing.

### BACKGROUND ART

In the past, immersive sound systems mainly for movie content have provided a sense of an acoustic field in a horizontal plane only, but now such systems also provide a sense of an acoustic field from on high.

In addition, some 22.2ch sound systems have front-side lower-layer loudspeakers. Further, in the field of consumer products, demand for immersive sound reproduction that covers an entire sphere in a game or VR (Virtual Reality), will increase in the future.

Needless to say, in such sound systems, a number of reproduction loudspeakers are required to be disposed not only in a horizontal plane but also on the upper-layer side and the lower-layer side.

In order to facilitate widespread use of such a sound system among consumer products, an increase of demand for a method for generating a large number of virtual loudspeakers by means of a small number of reproduction loudspeakers through signal processing is expected.

Meanwhile, in a representative method for implementing sound image localization, a head related transfer function (HRTF) is used (for example, see PTL 1).

In a case of implementing sound image localization using an HRTF, it is common to perform signal processing for convolution of an HRTF that corresponds to a direction in which a sound image is to be localized, with a desired audio signal.

Specifically, for example, as sound image localization filters corresponding to a predetermined direction, respective HRTFs for left and right ears in the predetermined direction are used, and each of the HRTFs for left and right ears is convoluted with a desired audio signal. Thus, signals for both left and right ears, that is, a left ear signal S1L and a right ear signal S1R, are obtained.

Further, in a case where sound image localization is to be further implemented in another direction at the same time, each of HRTFs for left and right ears in the other direction is convoluted with another desired audio signal, and thus, a left ear signal S2L and a right ear signal S2R are obtained.

Then, a signal obtained by adding up the left ear signals S1L and S2L and a signal obtained by adding up the right ear signals S1R and S2R are used as a final left ear signal and a final right ear signal, respectively.

### CITATION LIST

### Patent Literature

### [PTL 1]

PCT Patent Publication No. WO2017/119318

### SUMMARY

### Technical Problem

However, in a case where sound images are simultaneously localized in multiple directions according to the abovementioned technology, the amount of signal processing becomes large.

For example, in the abovementioned example, two sound image localization filters are required to simultaneously localize sound images in two directions. The amount of signal processing of convolution using the two sound image localization filters is two times larger than the amount of signal processing for localizing a sound image in one direction. Similarly, the amount of signal processing for localizing sound images in N directions simultaneously is N times larger than the amount of signal processing for localizing a sound image in one direction.

In the abovementioned immersive sound system, the number of directions in which sound images are to be localized tends to become great. As the number of the directions is greater, it is more difficult to ensure resources for signal processing.

The present technology has been made in view of such circumstances and enables reduction in the amount of signal processing.

### Solution to Problem

A signal processing device according to one aspect of the present technology includes a first convolution processing section and a notch forming section. The first convolution processing section performs convolution of an audio signal with a difference filter for adding a characteristic of a difference between a transmission characteristic of a path from a first position on a circumference of a cone of confusion to a listening position and a transmission characteristic of a path from a second position on the circumference to the listening position. The notch forming section performs a filtering process on a signal resulting from the convolution, by using a notch forming filter for forming a high-pass notch.

A signal processing method or program according to one aspect of the present technology includes the steps of performing convolution of an audio signal with a difference filter for adding a characteristic of a difference between a transmission characteristic of a path from a first position on a circumference of a cone of confusion to a listening position and a transmission characteristic of a path from a second position on the circumference to the listening position, and performing a filtering process on a signal resulting from the convolution, by using a notch forming filter for forming a high-pass notch.

According to the one aspect of the present technology, convolution of an audio signal is performed with the difference filter for adding a characteristic of the difference between the transmission characteristic of the path from the first position on the circumference of the cone of confusion to the listening position and the transmission characteristic of the path from the second position on the circumference to the listening position, and a filtering process is performed on a signal resulting from the convolution, by using the notch forming filter for forming a high-pass notch.

### BRIEF DESCRIPTION OF DRAWINGS

FIG. 1 is a diagram for explaining a cone of confusion.

FIG. 2 is a diagram for explaining sound image localization in a predetermined direction.

FIG. 3 is a diagram depicting an example of frequency characteristics of HRTFs.

FIG. 4 is a diagram depicting an example of frequency characteristics of HRTFs.

FIG. 5 is a diagram depicting a frequency characteristic difference between HRTFs.

FIG. 6 is a diagram for explaining sound image localization using a sunny-side HRTF difference filter.

FIG. 7 is a diagram for explaining sound image localization using a sunny-side HRTF difference filter.

FIG. 8 is a diagram for explaining achieving commonality of processing.

FIG. 9 is a diagram for explaining sound image localization in multiple directions.

FIG. 10 is a diagram depicting a configuration of a signal processing device.

FIG. 11 is a flowchart for explaining a reproduction process.

FIG. 12 is a diagram depicting a configuration of a signal processing device.

FIG. 13 is a flowchart for explaining a reproduction process.

FIG. 14 is a diagram for explaining sound image formation using reflection of a sound beam.

FIG. 15 is a diagram depicting a configuration of a signal processing device.

FIG. 16 is a flowchart for explaining a reproduction process.

FIG. 17 is a diagram depicting a configuration example of a computer.

### DESCRIPTION OF EMBODIMENTS

Hereinafter, embodiments to which the present technology is applied will be explained with reference to the drawings.

### First Embodiment

### <Present Technology>

In a case where sound image localization is implemented using HRTFs as sound image localization filters, the amount of signal processing becomes larger with an increase of the number of directions in which sound images are to be simultaneously localized, as previously explained.

In addition, in immersive sound systems, there is a tendency to increase the number of directions in which sound images are to be simultaneously localized. Thus, reduction in the amount of signal processing has been desired.

Meanwhile, as a common arrangement pattern of reproduction loudspeakers in an immersive sound system, there is often adopted an arrangement pattern in which upper-layer and lower-layer loudspeakers have azimuth angles equal to that of a loudspeaker disposed in a middle layer (horizontal plane) and have elevation angles (depression angles) different from that of the middle-layer loudspeaker, or an arrangement pattern in which the upper-layer and lower-layer loudspeakers are placed on the circumference of a cone of confusion of the loudspeaker disposed in the middle layer.

It is to be noted that, if the azimuth angles indicating positions where the loudspeakers are arranged are not large, the former arrangement pattern can be approximated to the latter arrangement pattern. That is, it can be said that the former arrangement pattern is substantially identical to the latter arrangement pattern in a case where, in the latter arrangement pattern, the difference in the azimuth angles between different positions of the loudspeakers on the circumference is small.

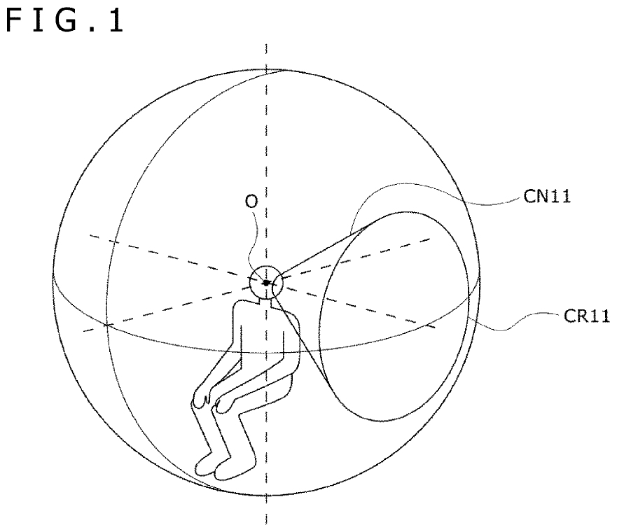

For example, when a head position of a user who is a listener is set to an origin O, a cone CN11 has a vertex at the origin O, that is, a listening position, as depicted in FIG. 1. Now, the cone CN11 is considered.

Here, it is assumed that a middle-layer loudspeaker is disposed on the circumference of a circle corresponding to a bottom surface (cross section) of the cone CN11, i.e., a circumference CR11, and that an upper-layer or lower-layer loudspeaker is also disposed on the circumference CR11.

Such a circumference CR11 on which the upper-layer or lower-layer loudspeaker and the middle-layer loudspeaker are all positioned is the circumference of the cone of confusion.

In other words, it can be said that a situation in which multiple loudspeakers are placed on the circumference CR11 of the cone of confusion, is regarded as a situation in which multiple loudspeakers are arranged in positions of equal distance from a position of a listener, i.e., the origin O set at a listening position.

Thus, when an upper-layer or lower-layer loudspeaker and a middle-layer loudspeaker are arranged on the circumference CR11 of the cone of confusion, listener interaural differences based on positions of the loudspeakers, that is, arrival times of sounds from the positions of the respective loudspeakers and volumes of the respective sounds, are substantially similar to one another.

Further, a timbre element, i.e., the frequency characteristic of an HRTF (the shape of a signal in a frequency domain), serves as a queue for determining a position on the circumference CR11 where a loudspeaker is arranged. In other words, the frequency characteristic of an HRTF is determined depending on a position of a loudspeaker on the circumference CR11.

By utilizing such a feature, for example, if localization of a middle-layer (horizontal plane) loudspeaker is preliminarily implemented using an actual or virtual loudspeaker, it is possible to obtain a sense of localization of an upper-layer or lower-layer loudspeaker positioned on the circumference of the cone of confusion on which the middle-layer loudspeaker is positioned, by only adding a timbre element to an HRTF corresponding to the middle-layer loudspeaker.

Therefore, in a case of localizing sound images in multiple positions on the same circumference, when part of signal processing for localizing the sound images in the respective positions is made common, it is possible to reduce the total amount of signal processing.

Thus, according to the present technology, part of signal processing is made common in a case where sound image localization in a predetermined direction has been implemented, that is, in a case where a sound image localization filter has been obtained. Consequently, a sound image localization filter corresponding to a direction of any position on the circumference of a cone of confusion including the predetermined direction can easily be obtained.

Hereinafter, a more specific explanation will be given regarding a case where an HRTF is used as a sound image localization filter.

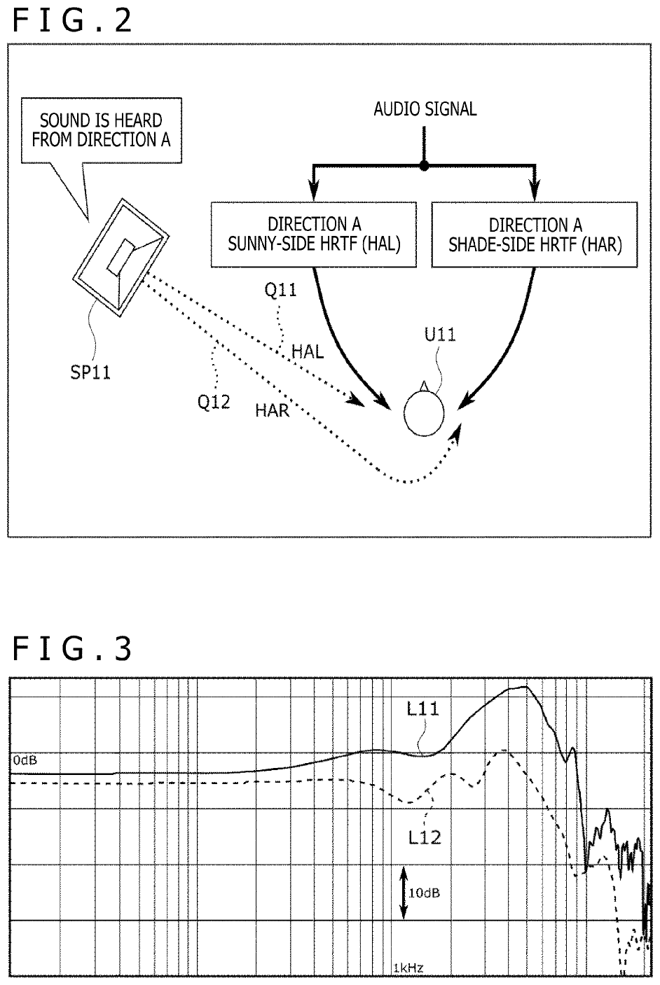

For example, it is assumed that, in a case where a sound based on a predetermined audio signal is to be reproduced through headphones, HRTFs for localizing a sound image in a position of a virtual loudspeaker SP11 that is placed on the front left side of a user U11, have already been obtained, as depicted in FIG. 2.

That is, it is assumed that a left ear HRTF that represents a transmission characteristic of a path from the position of the loudspeaker SP11 to the left ear of the user U11, as indicated by an arrow Q11, and a right ear HRTF that represents a transmission characteristic of a path from the position of the loudspeaker SP11 to the right ear of the user U11, as indicated by an arrow Q12, have already been obtained. In particular, it is assumed that the user U11 and the loudspeaker SP11 are positioned on a horizontal plane.

In addition, the direction from the loudspeaker SP11 to the user U11 is also referred to as a direction A. In particular, the left ear HRTF and the right ear HRTF obtained for the direction A are also referred to as a sound image localization filter HAL and a sound image localization filter HAR, respectively.

Further, hereinafter, the HRTF that represents the transmission characteristic of the path through which a sound directly arrives at the ear of the user U11, as indicated by the arrow Q11, is also referred to as a sunny-side HRTF.

Also, hereinafter, the HRTF that represents the transmission characteristic of the path through which a sound arrives at an ear of the user U11 after traveling around the head of the user U11, as indicated by the arrow Q12, is also referred to as a shade-side HRTF.

In other words, between the left and right ears of the user U11, an ear closer to the loudspeaker SP11 which is a sound source is defined as an ear on a sunny side, and an ear farther from the loudspeaker SP11 is defined as an ear on a shade side.

In this example, the left ear HRTF, i.e., the sound image localization filter HAL, is the sunny-side HRTF, while the right ear HRTF, i.e., the sound image localization filter HAR, is the shade-side HRTF.

In this case, a sound is reproduced on the basis of a signal obtained by performing a convolution process of an audio signal and the sunny-side HRTF, and the sound is presented to the left ear of the user U11. That is, with a left ear loudspeaker (driver) of headphones put on the user U11, a sound is reproduced on the basis of a signal resulting from the convolution process.

In contrast, on the right ear side of the user U11, a sound is reproduced on the basis of a signal obtained by performing a convolution process of the audio signal and the shade-side HRTF, and the sound is presented to the right ear of the user U11.

As a result, the user U11 can hear the sounds as if a sound image of a sound based on the audio signal is localized in the position of the loudspeaker SP11 That is, the user U11 can hear the sound based on the audio signal as if the sound is propagated from the direction A in which the loudspeaker SP11 is positioned.

Herein, obtaining of a sound image localization filter corresponding to a direction B, which is different from the direction A, from a predetermined position on the same circumference of a cone of confusion to the user U11, is discussed. The cone of confusion has a vertex at a head position of the user U11 which is a listening position, and includes the direction A, that is, includes the position of the loudspeaker SP11.

In this case, the loudspeaker SP11 and a virtual loudspeaker corresponding to the direction B are positioned on the circumference of the cone of confusion.

For example, even if multiple different positions are set on the same circumference of a cone of confusion, the shape of the difference between the frequency characteristics of the sunny-side HRTFs obtained for the respective positions (directions) may not necessarily be the same as the shape of the difference between the frequency characteristics of the shade-side HRTFs.

For example, when a position P1 is set such that an azimuth angle and an elevation angle are (azimuth angle, elevation angle)=(30 deg, 0 deg) when viewed from the user U11, an HRTF for a path from the position P1 to the user U11 is as depicted in FIG. 3.

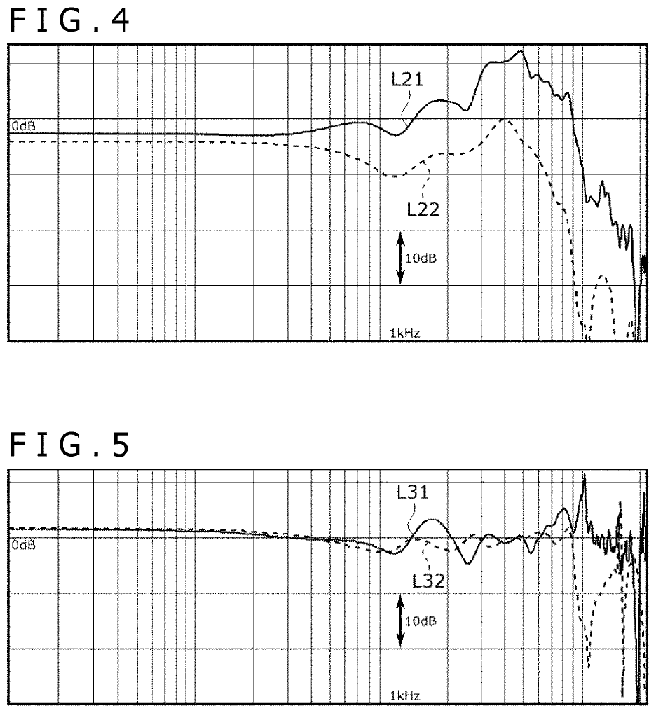

Similarly, when a position P2 is set such that an azimuth angle and an elevation angle are (azimuth angle, elevation angle)=(46 deg, 31 deg) when viewed from the user U11, an HRTF for a path from the position P2 to the user U11 is as depicted in FIG. 4. Here, the position P1 and the position P2 are on the same circumference of a cone of confusion.

In addition, the difference in frequency characteristics between the HRTF for the position P1 and the HRTF for the position P2 is depicted in FIG. 5.

It is to be noted that, in each of FIGS. 3 to 5, the horizontal axis represents a frequency, while the longitudinal axis represents a level.

In FIG. 3, a curve L11 indicates the frequency characteristic of the sunny-side HRTF for the position P1, and a curve L12 indicates the frequency characteristic of the shade-side HRTF for the position P1.

Further, in FIG. 4, a curve L21 indicates the frequency characteristic of the sunny-side HRTF for the position P2, and a curve L22 indicates the frequency characteristic of the shade-side HRTF for the position P2.

In addition, in FIG. 5, a curve L31 indicates the difference between the frequency characteristic of the sunny-side HRTF for the position P1, which is indicated by the curve L11 and the frequency characteristic of the sunny-side HRTF for the position P2, which is indicated by the curve L21.

Similarly, in FIG. 5, a curve L32 indicates the difference between the frequency characteristic of the shade-side HRTF for the position P1, which is indicated by the curve L12, and the frequency characteristic of the shade-side HRTF for the position P2, which is indicated by the curve L22.

Regarding such a position P1 and a position P2 as described above which are on the same circumference of the cone of confusion, if the difference in the frequency characteristics, i.e., the difference in spectrum shapes, between the HRTFs on the sunny side for these positions has the same shape as the shape of the difference on the shade side, the shape of the curve L31 should be the same as the shape of the curve L32 in FIG. 5.

However, as seen from FIG. 5, the shape of the curve L31 is different from that of the curve L32.

That is, as depicted in FIG. 5, the shape of the frequency characteristic difference between the sunny-side HRTF corresponding to the direction A and the sunny-side HRTF corresponding to the direction B is not necessarily the same as the shape of the frequency characteristic difference between the shade-side HRTF corresponding to the direction A and the shade-side HRTF corresponding to the direction B.

The frequency characteristic differences between HRTFs, which are indicated by the curve L31 and the curve L32, usually vary in a slightly complicated manner according to a frequency.

Therefore, although a timbre element, i.e., the frequency characteristic of an HRTF, should be determined depending on a position on the circumference of the cone of confusion, the same frequency characteristic change does not actually occur on the left and right ear when the position is changed.

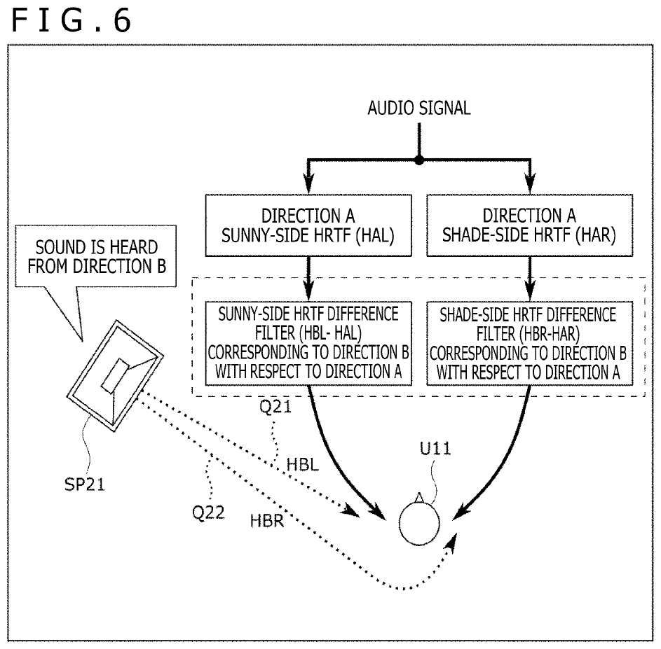

Here, in a case where an attempt is made to obtain sufficient reproducibility from both the sunny-side HRTF and the shade-side HRTF that correspond to the direction B described above, a sound based on an audio signal is only required to be reproduced by signal processing depicted in FIG. 6.

In FIG. 6, a direction from a virtual loudspeaker SP21 located in a position in which a sound image is to be localized, toward the user U11 is defined as direction B.

In addition, a left ear HRTF represents a transmission characteristic of a path from the loudspeaker SP21 to the left ear of the user U11, as indicated by an arrow Q21. Hereinafter, this left ear HRTF is also referred to as a sound image localization filter HBL.

Similarly, a right ear HRTF represents a transmission characteristic of a path from the loudspeaker SP21 to the right ear of the user U11, as indicated by an arrow Q22. Hereinafter, this right ear HRTF is also referred to as a sound image localization filter HBR.

In this example, the left ear HRTF, i.e., the sound image localization filter HBL, is a sunny-side HRTF, while the right ear HRTF, i.e., the sound image localization filter HBR, is a shade-side HRTF, as in the case in FIG. 2.

Here, the difference (HBL−HAL) between the sound image localization filter HBL corresponding to the direction B and the sound image localization filter HAL corresponding to the direction A is defined as a sunny-side HRTF difference filter corresponding to the direction B with respect to the direction A. In other words, the sunny-side HRTF difference filter corresponding to the direction B with respect to the direction A is a filter for adding a characteristic of the difference between a transmission characteristic of the sound image localization filter HBL and a transmission characteristic of the sound image localization filter HAL.

Similarly, the difference (HBR−HAR) between the sound image localization filter HBR corresponding to the direction B and the sound image localization filter HAR corresponding to the direction A is defined as a shade-side HRTF difference filter corresponding to the direction B with respect to the direction A.

Further, hereinafter, the sunny-side HRTF difference filter and the shade-side HRTF difference filter are each also simply referred to as a difference filter in a case where a distinction therebetween is not necessary.

In this case, a sound image can be localized such that a sound can be heard as if the sound is propagated from the direction B, with use of the sound image localization filter HAL, the sunny-side HRTF difference filter, the sound image localization filter HAR, and the shade-side HRTF difference filter.

In other words, by a combination of the sound image localization filter HAL, the sunny-side HRTF difference filter, the sound image localization filter HAR, and the shade-side HRTF difference filter, a sound image localization filter for localizing a sound image in the direction B can be obtained.

Specifically, on the left ear side, a convolution process (filtering process) is performed on an audio signal with use of the sound image localization filter HAL. That is, a convolution process of a filter coefficient (HRTF) constituting the sound image localization filter HAL and an audio signal is performed.

Then, a signal resulting from the convolution process is further subjected to a convolution process using the sunny-side HRTF difference filter. On the basis of the resultant signal, a sound is reproduced.

Similarly, on the right ear side, a convolution process is performed on an audio signal with use of the sound image localization filter HAR. A signal resulting from the convolution process is further subjected to a convolution process using the shade-side HRTF difference filter. On the basis of the resultant signal, a sound is reproduced.

Therefore, if the sound image localization filter HAL and the sound image localization filter HAR that correspond to the direction A have been prepared, and if the sunny-side HRTF difference filter and the shade-side HRTF difference filter are held as additional filters, sound image localization in the direction B can also be implemented.

In this case, however, two filters, that is, the sunny-side HRTF difference filter and the shade-side HRTF difference filter, are needed. This may not necessarily be efficient since sound image localization in the direction B can be implemented using the sound image localization filter HBL and the sound image localization filter HBR.

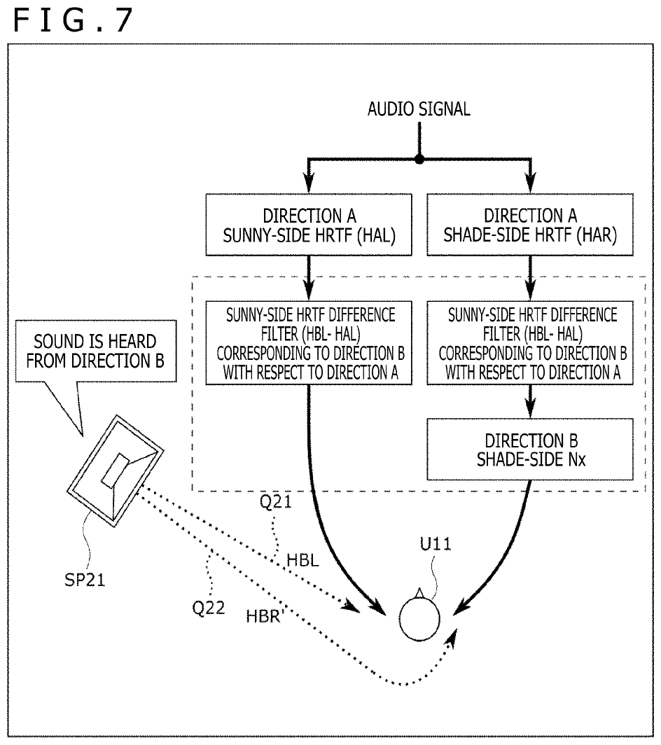

Therefore, as an additional difference filter on the shade side, that is, the right ear side in FIG. 7, a sunny-side HRTF difference filter is experimentally used to perform signal processing for sound image localization. It is to be noted that a part in FIG. 7 corresponding to that in FIG. 6 is denoted by the same reference sign, and an explanation thereof will be omitted, as appropriate.

In the example in FIG. 7, on the shade side (right ear side), the sunny-side HRTF difference filter is used as a difference filter, in place of the shade-side HRTF difference filter used in FIG. 6.

In this case, however, a high-pass notch in an HRTF which is considered to be important for a sense of localization is not reproduced on the shade side. Thus, a notch forming filter Nx is additionally provided on the shade side.

Specifically, on the sunny side (left ear side), processes similar to those in FIG. 6 are performed.

In contrast, on the shade side (right ear side), a convolution process using the sound image localization filter HAR is performed on an audio signal. A signal resulting from the convolution process is subjected to a convolution process using the sunny-side HRTF difference filter.

In addition, a filtering process using a notch forming filter Nx which is preliminarily obtained for the direction B is performed on a signal resulting from the convolution process using the sunny-side HRTF difference filter. On the basis of the resultant signal, a sound is reproduced.

In a high pass part of the frequency characteristic indicated by the curve L32 in FIG. 5, for example, a recess (dip) that is recessed to the lower side in FIG. 5 is called a notch (high-pass notch).

When a filtering process using the notch forming filter Nx is performed, a high-pass notch of a transmission characteristic of a path to the shade side in the direction B, that is, the frequency characteristic of the shade-side HRTF corresponding to the direction B is formed.

As a result of execution of the abovementioned processes depicted in FIG. 7, it has been confirmed that a desirable sense of localization can be obtained.

In the example in FIG. 7, although a characteristic of the shade-side HRTF corresponding to the direction B is not precisely reproduced, a timbre element difference obtained on the sunny side applies, as a timbre element difference from the direction A, to both the sunny side and the shade side, that is, to both ears.

In other words, a characteristic of the HRTF corresponding to the direction B may be applied to the sunny side while the difference in the frequency characteristics between both ears in the direction A are kept unchanged, whereby a sense of localization in the direction B can be obtained. This indicates that a timbre element of the sunny-side HRTF is important for a sense of localization.

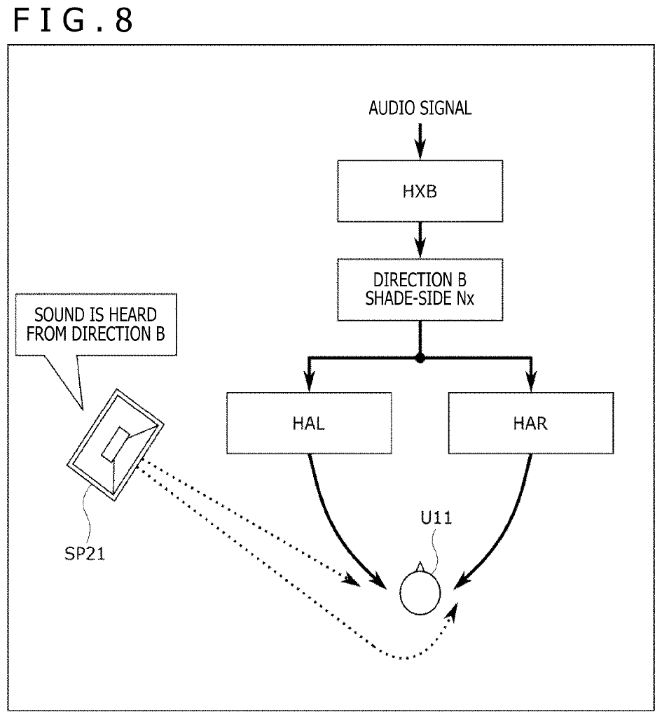

On the basis of the results as described above, in a case of implementing sound image localization in the direction B, signal processing can be simplified as depicted in FIG. 8. It is to be noted that a part in FIG. 8 corresponding to that in FIG. 7 is denoted by the same reference sign, and an explanation thereof will be omitted, as appropriate.

In FIG. 8, “HXB” indicates the sunny-side HRTF difference filter corresponding to the direction B with respect to the direction A, that is, the difference (HXB=HBL−HAL) between the sound image localization filter HBL and the sound image localization filter HAL.

Thus, in this example, a convolution process using the sunny-side HRTF difference filter HXB is first performed on an audio signal, and then, a filtering process using the notch forming filter Nx is performed on a signal resulting from the convolution process.

Here, the convolution process and the filtering process using the notch forming filter Nx are common to left and right ears. Accordingly, the amount of signal processing is reduced.

In particular, the present applicant has empirically confirmed that a sense of localization of a sound image is unaffected by forming a shade-side high-pass notch on the sunny side. Therefore, the filtering process using the notch forming filter Nx is also common to left and right ears.

In addition, on the left ear side, a convolution process of a signal resulting from the filtering process using the notch forming filter Nx, and the left ear HRTF, i.e., the sound image localization filter HAL, is performed. On the basis of the resultant signal, a sound is reproduced.

Similarly, on the right ear side, a convolution process of a signal resulting from the filtering process using the notch forming filter Nx, and the right ear HRTF, i.e., the sound image localization filter HAR, is performed. On the basis of the resultant signal, a sound is reproduced.

Since the convolution process using the sunny-side HRTF difference filter HXB and the filtering process using the notch forming filter Nx are common to left and right ears, as explained above, the amount of signal processing can be reduced.

That is, in a case where a sound image localization filter for a predetermined direction has been prepared, a sound image localization filter corresponding to a direction of any position located on the circumference of the cone of confusion including the predetermined direction can easily be obtained.

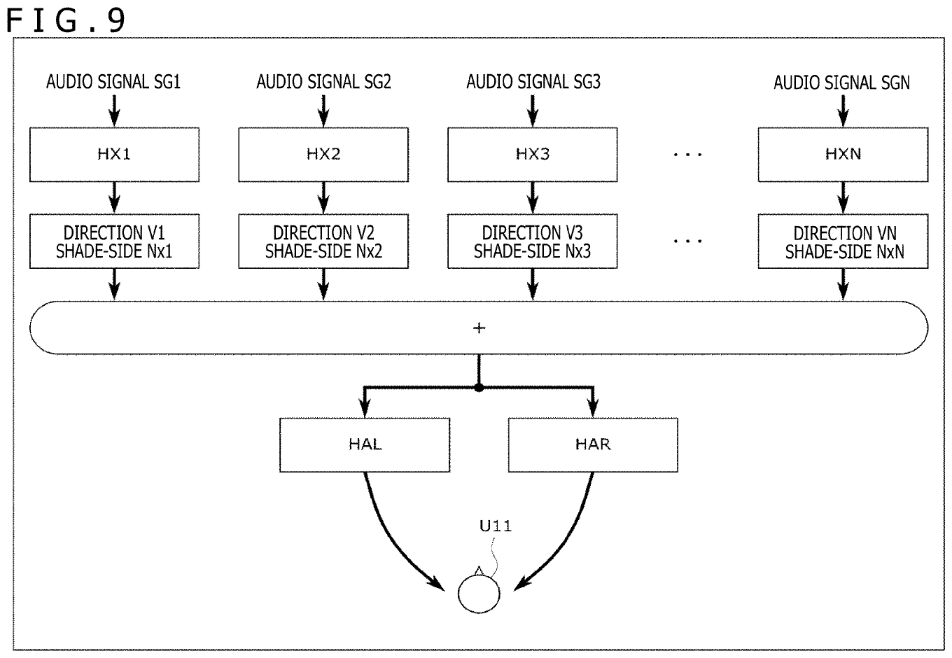

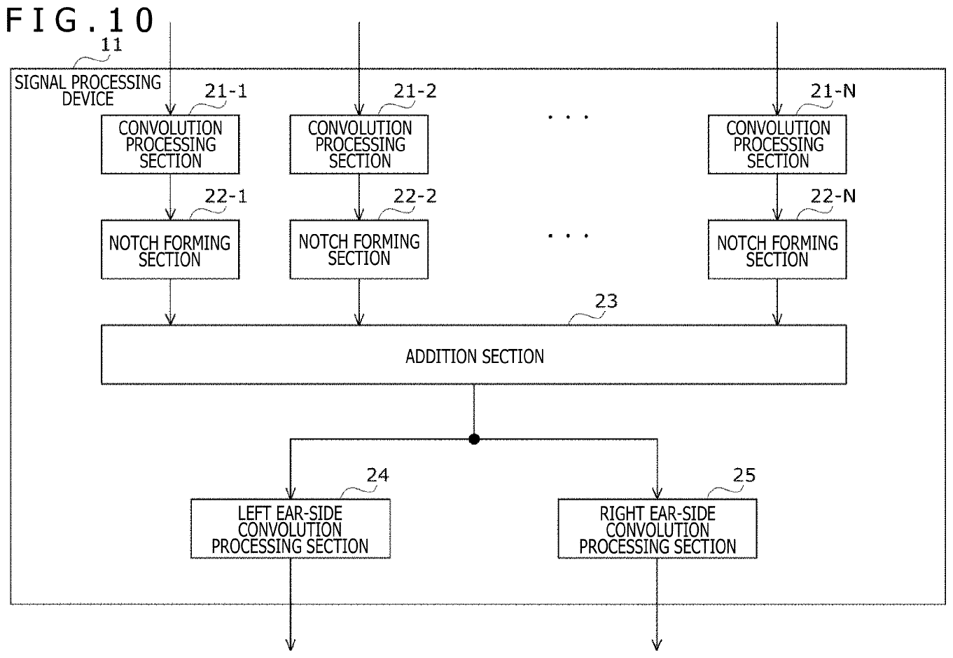

When part of the processing is commonized as depicted in FIG. 8, a filter for simultaneously localizing sound images in directions of N different positions on the same circumference of the cone of confusion including the abovementioned direction A, as depicted in FIG. 9, can be formed.

In the example in FIG. 9, audio signals for localizing respective sound images in directions V1 to VN of N different positions on the same circumference of the cone of confusion, are audio signals SG1 to SGN.

Further, sunny-side HRTF difference filters for the respective directions V1 to VN with respect to the direction A are sunny-side HRTF difference filters HX1 to HXN.

In addition, shade-side notch forming filters for the respective directions V1 to VN are notch forming filters Nx1 to NxN.

In this example, therefore, for each direction Vn (1≤n≤N), a convolution process using the sunny-side HRTF difference filter HXn is performed on the audio signal SGn. That is, a convolution process of the audio signal SGn and the sunny-side HRTF difference filter HXn is performed for each direction Vn.

Further, a signal resulting from the convolution process performed for each direction Vn (1≤n≤N), is subjected to a filtering process using a notch forming filter Nxn in the direction Vn. Signals resulting from the filtering process are added up, whereby an addition signal is generated.

Then, the addition signal obtained in such a manner is subjected to a convolution process using the sound image localization filter (HRTF) on the sunny side, and is also subjected to a convolution process using the sound image localization filter (HRTF) on the shade side.

Specifically, on the sunny side (left ear side), a convolution process of the addition signal and the sound image localization filter HAL, i.e., the sunny-side HRTF, is performed. On the basis of the resultant signal, a sound is reproduced. The sound is presented to the left ear of the user U11.

Similarly, on the shade side (right ear side), a convolution process of the addition signal and the sound image localization filter HAR, i.e., the shade-side HRTF, is performed. On the basis of the resultant signal, a sound is reproduced. The sound is presented to the right ear of the user U11.

A convolution process using a difference filter for each direction Vn is usually required for each of a sunny side and a shade side. However, in the present example, a convolution process using a difference filter for each direction Vn is made common to a sunny side and a shade side in such a manner as described above. Thus, the convolution process in the present example is a single process. Therefore, the amount of signal processing can be reduced.

Further, a convolution process of an HRTF corresponding to the direction A should necessarily be performed for each direction Vn and for each ear. However, in the present example, the process is common to all the directions Vn, and the number of the direction Vn does not matter. Therefore, the amount of signal processing can be further reduced.

In addition, an experiment carried out by the applicant demonstrates that, in order to obtain an effect of the sunny-side HRTF difference filter HXn, it is not necessary to set the entire audible band as a target of the filter. That is, in a convolution process using the sunny-side HRTF difference filter HXn, it is sufficient to set, as a target of the filter, a frequency band of approximately 10 kHz or lower, for example. In such a manner, the amount of signal processing can be further reduced.

Moreover, as the sunny-side HRTF difference filter HXn, an FIR (Finite Impulse Response) type filter may be used, or an IIR (Infinite Impulse Response) type filter may be simply used.

### Configuration Example of Signal Processing Device

Next, a signal processing device to which the present technology explained so far is applied will be explained.

FIG. 10 is a diagram depicting a configuration example of one embodiment of a signal processing device to which the present technology is applied.

A signal processing device 11 depicted in FIG. 10 includes convolution processing sections 21-1 to 21-N, notch forming sections 22-1 to 22-N, an addition section 23, a left ear-side convolution processing section 24, and a right ear-side convolution processing section 25.

The signal processing device 11 generates headphone reproduction signals for simultaneously localizing sound images in N different positions (directions) which are on the same circumference of the cone of confusion having a vertex set at a listening position, i.e., a head position of a user, as in the example explained previously with reference to FIG. 9.

Audio signals SG1 to SGN for localizing sound images in directions V1 to VN are supplied to the convolution processing sections 21-1 to 21-N, respectively.

It is to be noted that, hereinafter, each of the convolution processing sections 21-1 to 21-N is also simply referred to as a convolution processing section 21 in a case where a distinction therebetween is not necessary.

In addition, a sunny-side HRTF difference filter HXn for adding a characteristic of the difference between a sunny-side HRTF corresponding to a predetermined one direction Vm among the directions V1 to VN and a sunny-side HRTF corresponding to the direction Vn is preliminarily held in the convolution processing section 21-n (1≤n≤N). In other words, the sunny-side HRTF difference filter HXn is a sunny-side difference filter corresponding to the direction Vn with respect to the direction Vm.

The convolution processing section 21-n (1≤n≤N) performs a convolution process (filtering process) of a supplied audio signal SGn by using the sunny-side HRTF difference filter HXn, and supplies an audio signal SGn′ resulting from the convolution process to the notch forming section 22-n. That is, a convolution process of the audio signal SGn and the sunny-side HRTF difference filter HXn is performed.

It is to be noted that, hereinafter, each of the audio signals SG1 to SGN is also simply referred to as an audio signal SG in a case where a distinction therebetween is not necessary, and each of the audio signals SG1′ to SGN′ is also simply referred to as an audio signal SG′ in a case where a distinction therebetween is not necessary.

In addition, hereinafter, each of the sunny-side HRTF difference filters HX1 to HXN is also simply referred to as a sunny-side HRTF difference filter HX in a case where a distinction therebetween is not necessary.

The notch forming filter Nxn for forming a high-pass notch of a transmission characteristic of a path to the shade side in the direction Vn, i.e., a frequency characteristic of the shade-side HRTF corresponding to the direction Vn, is preliminarily held in the notch forming section 22-n (1≤n≤N).

The notch forming section 22-n (1≤n≤N) performs, on the audio signal SGn′ supplied from the convolution processing section 21-n, a filtering process based on the notch forming filter Nxn that is preliminarily held, and supplies an audio signal SGn″ resulting from the filtering process to the addition section 23.

It is to be noted that, hereinafter, each of the notch forming sections 22-1 to 22-N is also simply referred to as a notch forming section 22 in a case where a distinction therebetween is not necessary.

Further, hereinafter, each of the audio signals SG1″ to SGN″ is also simply referred to as an audio signal SG″ in a case where a distinction therebetween is not necessary, and each of the notch forming filters Nx1 to NxN is also simply referred to as a notch forming filter Nx in a case where a distinction therebetween is not necessary.

The addition section 23 obtains one addition signal by adding up the audio signals SG1″ to SGN″ supplied from the notch forming sections 22-1 to 22-N, and supplies the obtained addition signal to the left ear-side convolution processing section 24 and the right ear-side convolution processing section 25.

By performing a convolution process of the addition signal supplied from the addition section 23 and the left ear HRTF that is preliminarily held and that corresponds to the direction Vm, i.e., a left ear sound image localization filter, the left ear-side convolution processing section 24 generates a left ear headphone reproduction signal for reproducing a sound to be presented to the left ear of the user.

As previously explained, the left ear sound image localization filter corresponding to the direction Vm is an HRTF for adding a transmission characteristic of a path from the position corresponding to the direction Vm on the same circumference of the cone of confusion having a vertex set at the head position of the user, which is the listening position, to the left ear of the user.

The left ear-side convolution processing section 24 outputs the obtained left ear headphone reproduction signal to a left ear loudspeaker (driver) of headphones not depicted.

By performing a convolution process of the addition signal supplied from the addition section 23 and the right ear HRTF that is preliminarily held and that corresponds to the direction Vm, the right ear-side convolution processing section 25 generates a right ear headphone reproduction signal for reproducing a sound to be presented to the right ear of the user.

A right ear sound image localization filter corresponding to the direction Vm is an HRTF for adding a transmission characteristic of a path from the position corresponding to the direction Vm on the same circumference of the cone of confusion having a vertex set at the head position of the user, which is the listening position, to the right ear of the user.

The right ear-side convolution processing section 25 outputs the obtained right ear headphone reproduction signal to a right ear loudspeaker (driver) of headphones not depicted.

The process of generating a headphone reproduction signal by convolution of an HRTF, which is performed by each of the left ear-side convolution processing section 24 and the right ear-side convolution processing section 25, is called a binaural process.

It is to be noted that a reproduction device (device) to which a headphone reproduction signal is outputted is not limited to headphones. A headphone reproduction signal may be outputted to any device such as an earphone, as long as the device is mounted on an ear of a user. In addition, the signal processing device 11 may be incorporated in a headphone or the like.

### <Explanation of Reproduction Process>

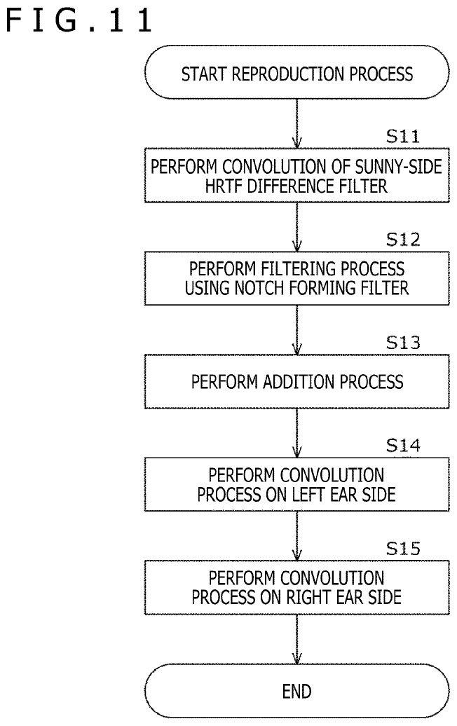

Next, operation of the signal processing device 11 will be explained. Specifically, with reference to a flowchart in FIG. 11, an explanation will be given below regarding a reproduction process which is performed by the signal processing device 11.

In step S11, each of N convolution processing sections 21 performs convolution of an audio signal SG supplied thereto and the sunny-side HRTF difference filter HX held therein, and supplies an audio signal SG′ resulting from the convolution to the notch forming section 22.

In step S12, each of N notch forming sections 22 performs a filtering process using the notch forming filter Nx on the audio signal SG′ supplied from the corresponding convolution processing section 21, and supplies an audio signal SG″ resulting from the filtering process to the addition section 23.

In step S13, the addition section 23 performs addition process to add up the audio signals SG″ supplied from the N notch forming sections 22, and supplies an addition signal resulting from the addition process, to the left ear-side convolution processing section 24 and the right ear-side convolution processing section 25.

In step S14, the left ear-side convolution processing section 24 performs a convolution process on the left ear side.

That is, the left ear-side convolution processing section 24 performs convolution of the addition signal supplied from the addition section 23 and the left ear HRTF corresponding to the direction Vm, and a left ear headphone reproduction signal is thus obtained.

In step S15, the right ear-side convolution processing section 25 performs a convolution process on the right ear side.

That is, the right ear-side convolution processing section 25 performs convolution of the addition signal supplied from the addition section 23 and the right ear HRTF corresponding to the direction Vm, and a right ear headphone reproduction signal is thus obtained.

After the left and right ear headphone reproduction signals are obtained in such a manner, the left ear-side convolution processing section 24 and the right ear-side convolution processing section 25 output the obtained headphone reproduction signals to a next stage to reproduce sounds. Thus, the reproduction process is completed.

Accordingly, sounds are reproduced with headphones as if the sounds are heard from the respective directions V1 to VN.

In such a manner as described above, the signal processing device 11 performs convolution of a sunny-side HRTF difference filter HX and an audio signal for each direction, forms a high-pass notch in the audio signal, and then adds up the resultant audio signals. Further, the signal processing device 11 generates a headphone reproduction signal by performing convolution of an HRTF corresponding to the direction Vm with an addition signal resulting from the adding.

In such a manner, commonality of part of processing is achieved, and the amount of signal processing can thus be reduced.

### Second Embodiment

### Configuration Example of Signal Processing Device

Reproduction with headphones has been explained above. However, sounds may be reproduced with two or more loudspeakers.

In such a case, for example, after the last stage of the processing which has been explained with reference to FIG. 9, that is, after a binaural process through convolution of a sound image localization filter (HRTF), it is sufficient if a crosstalk cancellation process is further performed to generate loudspeaker reproduction signals for reproducing sounds with multiple loudspeakers.

That is, the binaural process at the last stage in the example having been explained with reference to FIG. 9 is only required to be replaced with a transaural process which includes a binaural process and a crosstalk cancellation process.

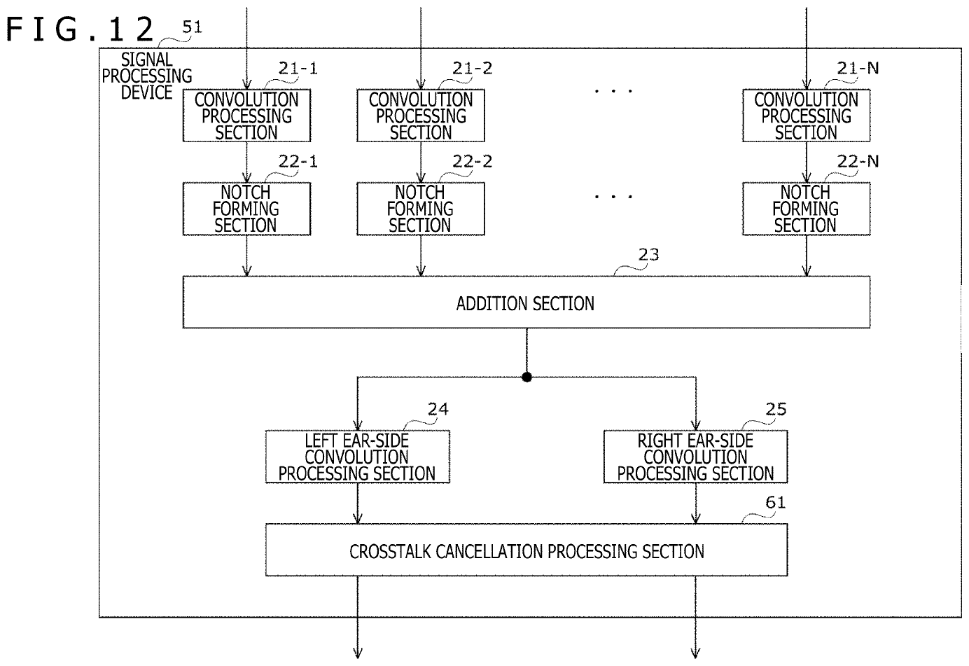

In a case of reproducing sounds in the respective directions V1 to VN with two loudspeakers, for example, a signal processing device is configured similarly to the signal processing device 11, as depicted in FIG. 12.

It is to be noted that a section in FIG. 12 corresponding to that in FIG. 10 is denoted by the same reference sign, and an explanation thereof will be omitted, as appropriate.

A signal processing device 51 depicted in FIG. 12 includes the convolution processing sections 21-1 to 21-N, the notch forming sections 22-1 to 22-N, the addition section 23, the left ear-side convolution processing section 24, the right ear-side convolution processing section 25, and a crosstalk cancellation processing section 61.

The configuration of the signal processing device 51 is different from that of the signal processing device 11 in FIG. 10 in that the crosstalk cancellation processing section 61 is provided, but the other sections in the signal processing device 51 are identical to those in the signal processing device 11.

The crosstalk cancellation processing section 61 generates loudspeaker reproduction signals for respective loudspeakers by performing a crosstalk cancellation process on the basis of a headphone reproduction signal supplied from the left ear-side convolution processing section 24 and a headphone reproduction signal supplied from the right ear-side convolution processing section 25.

The crosstalk cancellation processing section 61 outputs the loudspeaker reproduction signals to the respective loudspeakers to reproduce sounds.

Accordingly, a user who is listening to the sounds outputted from the loudspeakers, can feel as if the sounds are heard from the respective directions V1 to VN.

### <Explanation of Reproduction Process>

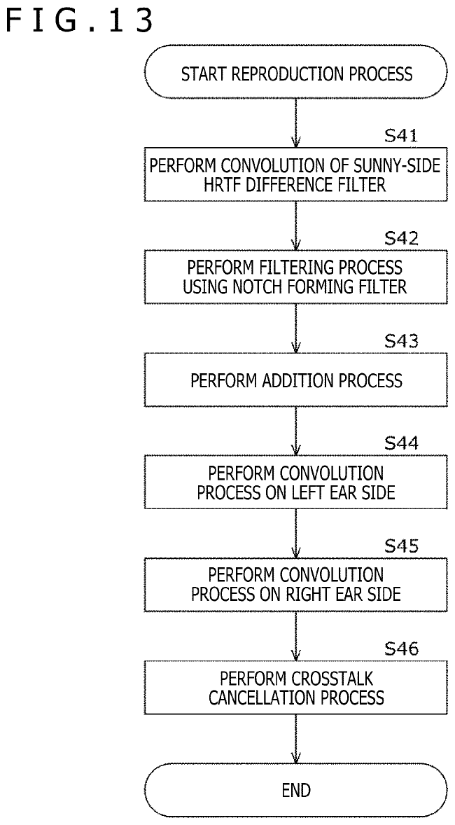

Next, operation of the signal processing device 51 will be explained. Specifically, with reference to a flowchart in FIG. 13, an explanation will be given below regarding a reproduction process which is performed by the signal processing device 51.

It is to be noted that steps S41 to S45 are similar to steps S11 to S15 in FIG. 11, and an explanation thereof will be omitted.

However, left ear and right ear headphone reproduction signals obtained in step S44 and step S45 are supplied from the left ear-side convolution processing section 24 and the right ear-side convolution processing section 25 to the crosstalk cancellation processing section 61.

In step S46, the crosstalk cancellation processing section 61 generates loudspeaker reproduction signals for respective loudspeakers by performing a crosstalk cancellation process on the basis of the headphone reproduction signals supplied from the left ear-side convolution processing section 24 and the right ear-side convolution processing section 25.

After the loudspeaker reproduction signals are obtained in such a manner as described above, the crosstalk cancellation processing section 61 outputs the loudspeaker reproduction signals to the corresponding loudspeakers. Thus, the reproduction process is completed.

As described above, the signal processing device 51 generates a loudspeaker reproduction signal by performing a crosstalk cancellation process on the basis of headphone reproduction signals resulting from convolution of the sunny-side HRTF difference filter HX, formation of a notch, an addition process, and convolution of an HRTF corresponding to the direction Vm. In such a manner, the amount of signal processing can also be reduced, as in the case of using the signal processing device 11.

### Third Embodiment

### Configuration Example of Signal Processing Device

Meanwhile, in recent years, a technology of causing a sound beam to be reflected by a wall and forming a sound image in the reflection direction has been proposed. To such a technology, the present technology is applicable.

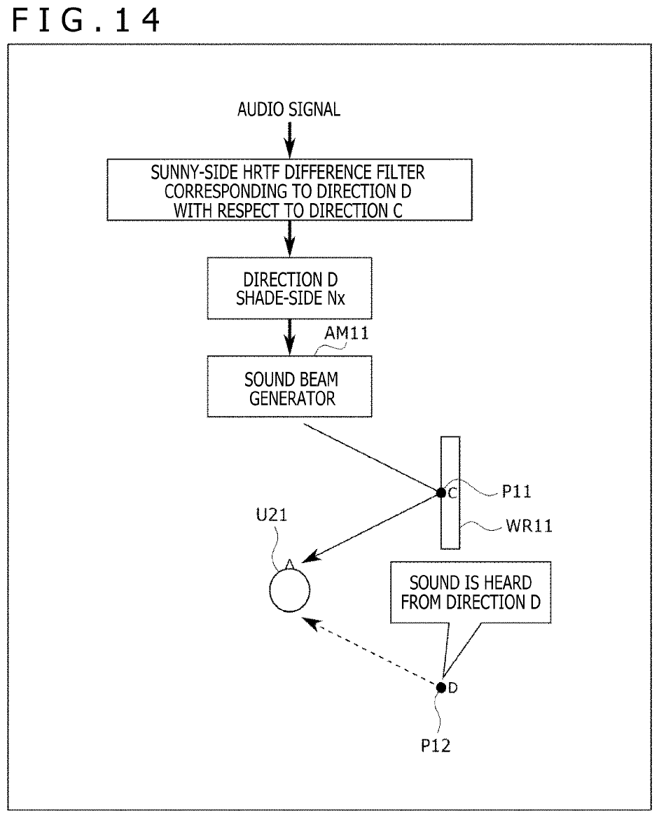

For example, as depicted in FIG. 14, a wall WR11 is positioned on the front right side of a user U21 who is a listener such that a sound beam outputted from a sound beam generator AM11 is reflected by the wall WR11 and that a sound based on the sound beam is presented to the user U21.

Here, when a sound beam is outputted from the sound beam generator AM11 to the wall WR11 on the basis of an audio signal for reproducing a sound of a predetermined sound source, for example, the sound beam arrives at an ear of the user U21 in a listening position after being reflected by the wall WR11.

In this case, the user U21 feels that, from the direction of the wall WR11 (hereinafter, also referred to as a direction C), the sound beam arrives at the user U21.

Accordingly, the user U21 feels as if the sound is heard from the direction C. That is, a sound image based on the sound beam is localized in the direction C when viewed from the user U21.

Here, a point P11 on the wall WR11 is a reflection point of a sound beam, and a point P12 is a point to which the distance from user U21 is equal to the distance from the user U21 to the point P11. In other words, the point P11 and the point P12 are on the same circumference of the cone of confusion when viewed from the user U21. Hereinafter, the direction from the user U21 to the point P12 is also referred to as a direction D.

The point P11 which is the reflection point of a sound beam and the point P12 are on the same circumference of the cone of confusion. Therefore, when a sound beam is outputted from the sound beam generator AM11 according to the present technology, the sound beam (reflected sound) physically comes from the direction C, but the user can hear sounds as if the sound beam comes from the direction D.

In such a case, it is sufficient if a sunny-side HRTF difference filter which represents the difference between a sunny-side HRTF (sound image localization filter) corresponding to the direction C and a sunny-side HRTF corresponding to the direction D, and a notch forming filter Nx for forming a high-pass notch on the shade side in the direction D, are prepared.

In this example, the right ear side of the user U21 is the sunny side in the direction C. Therefore, a sunny-side HRTF corresponding to the direction C is a sound image localization filter for adding a transmission characteristic of a path from the sound beam generator AM11 to the right ear of the user U21 in a case where a sound beam is outputted from the sound beam generator AM11, is reflected by the point P11, and arrives at the right ear of the user U21.

Further, a sunny-side HRTF corresponding to the direction D is a sound image localization filter for adding a transmission characteristic of a path from the point P12 to the right ear of the user U21.

In sound reproduction, convolution of a sunny-side HRTF difference filter corresponding to the direction D with respect to the direction C and an audio signal of a sound from a sound source to be reproduced, is performed, and a filtering process using the notch forming filter Nx is performed on a signal resulting from the convolution.

As a result of these processes, a characteristic of the frequency characteristic difference between the direction C and the direction D is added, and further, a reproduction signal in which a high-pass notch is formed is obtained.

The sound beam generator AM11 generates a sound beam on the basis of the reproduction signal obtained in such a manner, and outputs the sound beam toward the point P11 on the wall WR11.

As a result, the sound beam outputted from the sound beam generator AM11 arrives at the user U21 after being reflected by the point P11 on the wall WR11.

At this time, the sound beam propagates actually from the direction C to the user U21, but the user U21 feels as if the user is hearing the sound from the direction D. That is, the user can obtain a hearing feeling of a sense of localization in the direction D.

If the sound beam generator AM11 or the like can be placed in a position in the direction D from the user U21, for example, a sound beam is only required to be simply outputted from the position toward the user U21. However, in some cases, the sound beam generator AM11 cannot be placed in a desired position.

Even in such a case, the present technology can present a sense of localization in any direction, by simply performing a convolution process using a sunny-side HRTF difference filter and a filtering process using a notch forming filter, without involving a position change of the sound beam generator AM11.

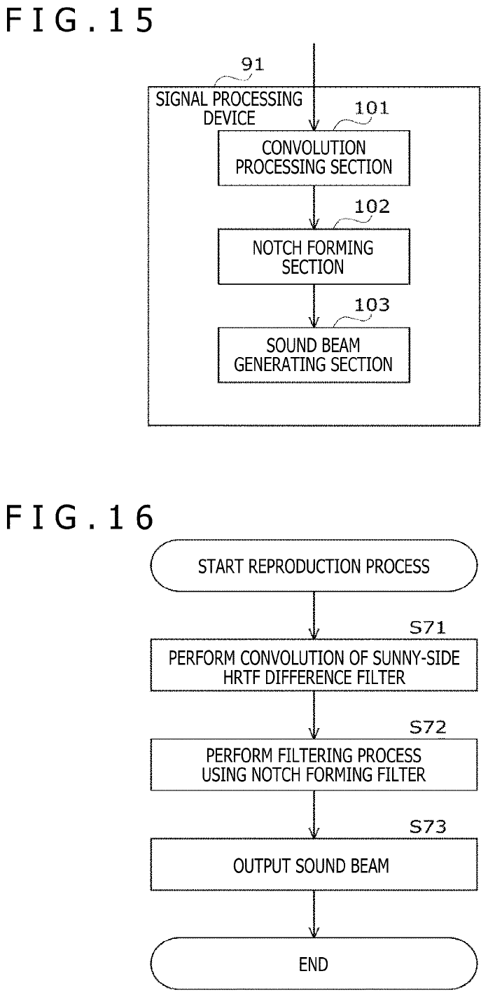

A signal processing device for presenting a sense of localization in a desired direction by causing a sound beam to be reflected by a wall or the like, in the above manner, has a configuration depicted in FIG. 15, for example.

A signal processing device 91 depicted in FIG. 15 includes a convolution processing section 101, a notch forming section 102, and a sound beam generating section 103.

As in the example having been explained with reference to FIG. 14, the signal processing device 91 is configured to cause, for example, a sound beam to be reflected by a wall such that, from a predetermined direction C when viewed from a user who is a listener, the sound beam arrives at the user.

In addition, it is assumed that the direction D in which a sound image is to be localized is preliminarily determined and that a position in the direction C and a position in the direction D from the user are on the same circumference of the cone of confusion having a vertex set at a listening position, i.e., the head position of the user.

A sunny-side HRTF difference filter for adding a characteristic of the difference between the sunny-side HRTF corresponding to the direction C and the sunny-side HRTF corresponding to the direction D is preliminarily held in the convolution processing section 101. In addition, an audio signal SG for localizing a sound image in the direction D is supplied to the convolution processing section 101.

The convolution processing section 101 performs convolution of the supplied audio signal SG and the held sunny-side HRTF difference filter, and supplies an audio signal SG′ resulting from the convolution to the notch forming section 102.

A notch forming filter Nx for forming a high-pass notch on the shade side in the direction D is preliminarily held in the notch forming section 102.

The notch forming section 102 performs, on the audio signal SG′ supplied from the convolution processing section 101, a filtering process based on the notch forming filter Nx that is preliminarily held, and supplies an audio signal SG″ resulting from the filtering process to the sound beam generating section 103.

The sound beam generating section 103 includes an ultrasonic loudspeaker or other loudspeakers, for example, and outputs a sound beam having a directivity in a predetermined direction, on the basis of the audio signal SG″ supplied from the notch forming section 102. That is, the sound beam generating section 103 outputs a sound having the directivity.

### <Explanation of Reproduction Process>

Next, operation of the signal processing device 91 will be explained. Specifically, with reference to a flowchart in FIG. 16, an explanation will be given below regarding a reproduction process which is performed by the signal processing device 91.

In step S71, the convolution processing section 101 performs convolution of the supplied audio signal SG and the held sunny-side HRTF difference filter corresponding to the direction D with respect to the direction C, and supplies an audio signal SG′ resulting from the convolution to the notch forming section 102.

In step S72, the notch forming section 102 performs, on the audio signal SG′ supplied from the convolution processing section 101, a filtering process based on the shade-side notch forming filter Nx corresponding to the direction D, and an audio signal SG″ resulting from the filtering process to the sound beam generating section 103.

In step S73, the sound beam generating section 103 generates a sound beam having a directivity in a predetermined direction, on the basis of the audio signal SG″ supplied from the notch forming section 102, and outputs the sound beam. In other words, the sound beam generating section 103 outputs a sound beam toward the predetermined direction such that the sound beam arrives at the user in the listening position after being reflected by a wall or the like.

Accordingly, the sound beam arrives at the user physically from the direction C, but sound reproduction for making the user feel as if a sound comes from the direction D is implemented.

As explained so far, the signal processing device 91 performs convolution of an audio signal and a sunny-side HRTF difference filter, and forms a notch in the audio signal. Then, the signal processing device 91 generates a sound beam on the basis of the resultant audio signal, and outputs the sound beam.

In such a manner, a sense of localization in any direction can easily be obtained.

### Configuration Example of Computer

The abovementioned series of processes can be executed by hardware, or can be executed by software. In the case where the series of processes is executed by software, a program forming the software is installed into a computer. Here, examples of the computer include a computer incorporated in dedicated-hardware, and a general-purpose personal computer capable of executing various functions by installing various programs thereinto.

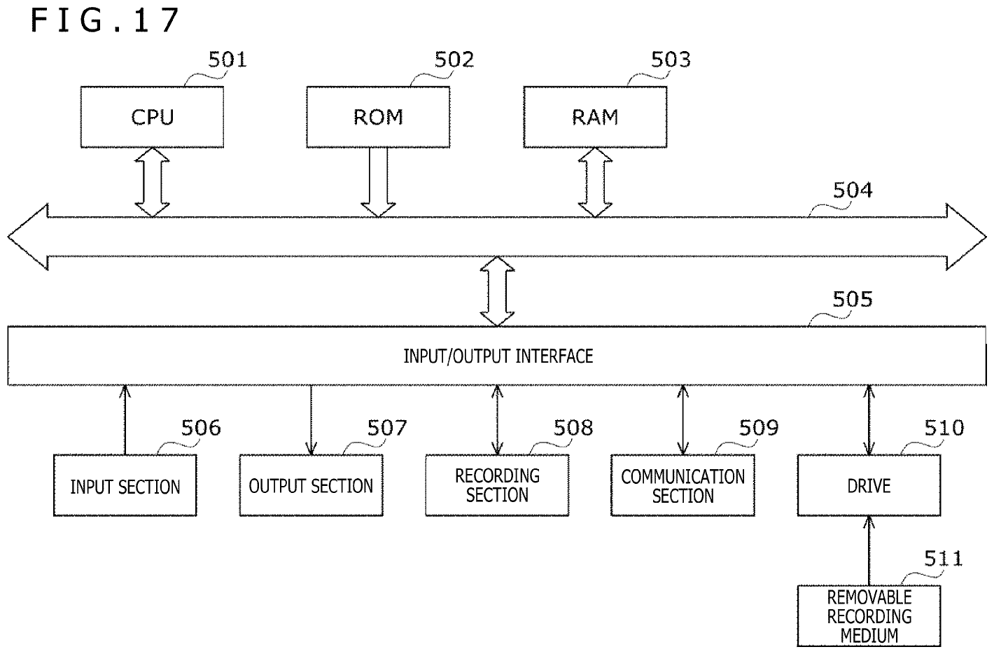

FIG. 17 is a block diagram depicting a hardware configuration example of a computer that executes the abovementioned processes according to a program.

In the computer, a CPU (Central Processing Unit) 501, a ROM (Read Only Memory) 502, and a RAM (Random Access Memory) 503 are mutually connected via a bus 504.

Further, an input/output interface 505 is connected to the bus 504. An input section 506, an output section 507, a recording section 508, a communication section 509, and a drive 510 are connected to the input/output interface 505.

The input section 506 includes a keyboard, a mouse, a microphone, an imaging element, or the like. The output section 507 includes a display, a loudspeaker, or the like. The recording section 508 includes a hard disk, a nonvolatile memory, or the like. The communication section 509 includes a network interface or the like. The drive 510 drives a removable recording medium 511 which is a magnetic disk, an optical disk, a magneto-optical disk, a semiconductor memory, or the like.

In the computer having the abovementioned configuration, the CPU 501 loads a program recorded in the recording section 508, for example, into the RAM 503 via the input/output interface 505 and the bus 504, and executes the program. Accordingly, the abovementioned series of processes is executed.

The program which is executed by the computer (CPU 501) can be provided by being recorded in the removable recording medium 511 serving as a package medium, for example. Alternatively, the program can be provided via a wired or wireless transmission medium such as a local area network, the Internet, or digital satellite broadcasting.

In the computer, when the removable recording medium 511 is attached to the drive 510, the program can be installed into the recording section 508 via the input/output interface 505. In addition, the program can be received at the communication section 509 via a wired or wireless transmission medium, and be installed into the recording section 508. Alternatively, the program can be preliminarily installed in the ROM 502 and the recording section 508.

It is to be noted that the program which is executed by the computer may be a program for executing the processes in the time-series order explained herein, or may be a program for executing the processes at a necessary timing such as a timing when a call is made.

In addition, embodiments of the present technology are not limited to the abovementioned embodiments, and various changes can be made within the scope of the gist of the present technology.

For example, the present technology can employ a configuration of cloud computing in which one function is shared and cooperatively processed by multiple devices over a network.

In addition, the respective steps having been explained with reference to the abovementioned flowcharts can be executed by one device, or can cooperatively be executed by multiple devices.

Moreover, in a case where multiple processes are included in one step, the multiple processes included in the one step can be executed by one device, or can cooperatively be executed by multiple devices.

Furthermore, the present technology can also have the following configurations.

(1)

A signal processing device including:

a first convolution processing section that performs convolution of an audio signal with a difference filter for adding a characteristic of a difference between a transmission characteristic of a path from a first position on a circumference of a cone of confusion to a listening position and a transmission characteristic of a path from a second position on the circumference to the listening position; and

a notch forming section that performs a filtering process on a signal resulting from the convolution, by using a notch forming filter for forming a high-pass notch.

(2)

The signal processing device according to (1), in which

the difference filter adds a characteristic of a difference between a transmission characteristic of a path from the first position to an ear of a user that is closer to the first position, the user being in the listening position, and a transmission characteristic of a path from the second position to an ear of the user that is closer to the second position.

(3)

The signal processing device according to (1) or (2), further including:

a second convolution processing section that performs convolution of a signal resulting from the filtering process, with a sound image localization filter for adding the transmission characteristic of the path from the first position to the listening position.

(4)

The signal processing device according to (3), further including:

an addition section that adds up signals individually obtained for a plurality of the different second positions on the circumference, each of the signals resulting from the convolution with the difference filter and from the filtering process using the notch forming filter, in which

the second convolution processing section performs convolution of a signal resulting from the adding, with the sound image localization filter.

(5)

The signal processing device according to (1) or (2), further including:

a left ear-side convolution processing section that performs convolution of a signal resulting from the filtering process, with a left ear sound image localization filter for adding a transmission characteristic of a path from the first position to a left ear of a user who is in the listening position; and

a right ear-side convolution processing section that performs convolution of the signal resulting from the filtering process, with a right ear sound image localization filter for adding a transmission characteristic of a path from the first position to a right ear of the user.

(6)

The signal processing device according to (5), in which

the notch forming filter forms a high-pass notch of a transmission characteristic of a path from the second position to an ear of the user that is farther from the second position.

(7)

The signal processing device according to (6), further including:

an addition section that adds up signals individually obtained for a plurality of the different second positions on the circumference, each of the signals resulting from the convolution with the difference filter and from the filtering process using the notch forming filter, in which

the left ear-side convolution processing section performs convolution of a signal resulting from the adding, with the left ear sound image localization filter, and

the right ear-side convolution processing section performs convolution of the signal resulting from the adding, with the right ear sound image localization filter.

(8)

The signal processing device according to any one of (5) to (7), further including:

a crosstalk cancellation processing section that performs a crosstalk cancellation process on the basis of a signal resulting from the convolution with the left ear sound image localization filter and a signal resulting from the convolution with the right ear sound image localization filter.

(9)

The signal processing device according to (1) or (2), further including:

a sound beam generating section that outputs a sound beam having a directivity, on the basis of a signal resulting from the filtering process.

(10)

The signal processing device according to (9), in which

the sound beam generating section outputs the sound beam toward a predetermined direction in such a manner that the sound beam arrives at the listening position after being reflected.

(11)

A signal processing method including:

by a signal processing device,

performing convolution of an audio signal with a difference filter for adding a characteristic of a difference between a transmission characteristic of a path from a first position on a circumference of a cone of confusion to a listening position and a transmission characteristic of a path from a second position on the circumference to the listening position; and

performing a filtering process on a signal resulting from the convolution, by using a notch forming filter for forming a high-pass notch.

(12)

A program for causing a computer to execute processing including the steps of:

performing convolution of an audio signal with a difference filter for adding a characteristic of a difference between a transmission characteristic of a path from a first position on a circumference of a cone of confusion to a listening position and a transmission characteristic of a path from a second position on the circumference to the listening position; and

performing a filtering process on a signal resulting from the convolution, by using a notch forming filter for forming a high-pass notch.

### REFERENCE SIGNS LIST

11: Signal processing device
21-1 to 21-N, 21: Convolution processing section
22-1 to 22-N, 22: Notch forming section
23: Addition section
24: Left ear-side convolution processing section
25: Right ear-side convolution processing section
61: Crosstalk cancellation processing section
101: Convolution processing section
102: Notch forming section
103: Sound beam generating section

1. A signal processing device comprising:
a first convolution processing section that performs convolution of an audio signal with a difference filter for adding a characteristic of a difference between a transmission characteristic of a path from a first position on a circumference of a cone of confusion to a listening position and a transmission characteristic of a path from a second position on the circumference to the listening position; and
a notch forming section that performs a filtering process on a signal resulting from the convolution, by using a notch forming filter for forming a high-pass notch.

2. The signal processing device according to claim 1, wherein
the difference filter adds a characteristic of a difference between a transmission characteristic of a path from the first position to an ear of a user that is closer to the first position, the user being in the listening position, and a transmission characteristic of a path from the second position to an ear of the user that is closer to the second position.

3. The signal processing device according to claim 1, further comprising:
a second convolution processing section that performs convolution of a signal resulting from the filtering process, with a sound image localization filter for adding the transmission characteristic of the path from the first position to the listening position.

4. The signal processing device according to claim 3, further comprising:
an addition section that adds up signals individually obtained for a plurality of the different second positions on the circumference, each of the signals resulting from the convolution with the difference filter and from the filtering process using the notch forming filter, wherein
the second convolution processing section performs convolution of a signal resulting from the adding, with the sound image localization filter.

5. The signal processing device according to claim 1, further comprising:
a left ear-side convolution processing section that performs convolution of a signal resulting from the filtering process, with a left ear sound image localization filter for adding a transmission characteristic of a path from the first position to a left ear of a user who is in the listening position; and
a right ear-side convolution processing section that performs convolution of the signal resulting from the filtering process, with a right ear sound image localization filter for adding a transmission characteristic of a path from the first position to a right ear of the user.

6. The signal processing device according to claim 5, wherein
the notch forming filter forms a high-pass notch of a transmission characteristic of a path from the second position to an ear of the user that is farther from the second position.

7. The signal processing device according to claim 6, further comprising:
an addition section that adds up signals individually obtained for a plurality of the different second positions on the circumference, each of the signals resulting from the convolution with the difference filter and from the filtering process using the notch forming filter, wherein
the left ear-side convolution processing section performs convolution of a signal resulting from the adding, with the left ear sound image localization filter, and
the right ear-side convolution processing section performs convolution of the signal resulting from the adding, with the right ear sound image localization filter.

8. The signal processing device according to claim 5, further comprising:
a crosstalk cancellation processing section that performs a crosstalk cancellation process on a basis of a signal resulting from the convolution with the left ear sound image localization filter and a signal resulting from the convolution with the right ear sound image localization filter.

9. The signal processing device according to claim 1, further comprising:
a sound beam generating section that outputs a sound beam having a directivity, on a basis of a signal resulting from the filtering process.

10. The signal processing device according to claim 9, wherein
the sound beam generating section outputs the sound beam toward a predetermined direction in such a manner that the sound beam arrives at the listening position after being reflected.

11. A signal processing method comprising:
by a signal processing device,
performing convolution of an audio signal with a difference filter for adding a characteristic of a difference between a transmission characteristic of a path from a first position on a circumference of a cone of confusion to a listening position and a transmission characteristic of a path from a second position on the circumference to the listening position; and
performing a filtering process on a signal resulting from the convolution, by using a notch forming filter for forming a high-pass notch.

12. A program for causing a computer to execute processing including the steps of:
performing convolution of an audio signal with a difference filter for adding a characteristic of a difference between a transmission characteristic of a path from a first position on a circumference of a cone of confusion to a listening position and a transmission characteristic of a path from a second position on the circumference to the listening position; and
performing a filtering process on a signal resulting from the convolution, by using a notch forming filter for forming a high-pass notch.
